(19) United States
(12) Patent Application Publication
(10) Pub. No.: US 2016/0114709 A1
(43) Pub. Date: Apr. 28, 2016

(54) VENTILATION SEAT FOR VEHICLE

(71) Applicants: Hyundai Motor Company, Seoul (KR); Kia Motors Corporation, Seoul (KR)

(72) Inventors: Mu Young KIM, Hwaseong-si (KR); Seon Chae NA, Yongin-si (KR); Chan Ho JEONG, Gunpo-si (KR); Jong Moon YOO, Hwaseong-si (KR)

(73) Assignees: KIA MOTORS CORPORATION; HYUNDAI MOTOR COMPANY

(21) Appl. No.: 14/851,865

(22) Filed: Sep. 11, 2015

(30) Foreign Application Priority Data
Oct. 28, 2014 (KR) 10-2014-0147143

(51) Int. Cl. B60N 2/56

(52) U.S. Cl. CPC B60N 2/5628

(57) ABSTRACT

A ventilation seat for a vehicle includes a seat pad having opposing lower and upper portions. The lower portion has an air branching channel formed therein. The seat pad has a plurality of air discharge holes arranged in a configuration that matches the air branching channel. The air discharge holes penetrated from the upper portion to the lower portion of the seat pad. A channel finish plate is attached to the lower portion of the seat pad and seals the air branching channel. The channel finish plate includes a duct connection hole penetrating therethrough.

### CROSS-REFERENCE TO RELATED APPLICATION

This application claims under 35 U.S.C. §119(a) the benefit of priority to Korean Patent Application No. 10-2014-0147143 filed on Oct. 28, 2014, the entire contents of which are incorporated herein by reference.

### TECHNICAL FIELD

The present disclosure relates to a ventilation seat for a vehicle. More particularly, it relates to a ventilation seat for a vehicle which is newly improved in a structure to prevent a phenomenon in which an air flow hole is clogged by a load of a passenger as well as a structure to easily discharge air on the surface of a seat without a clogging phenomenon.

### BACKGROUND

When a passenger sits on a seat for a vehicle for a long time, ventilation for a body part (in particular, a hip part) of the passenger which closely contacts the seat is not smooth, and as a result, sweat is generated from the body part that closely contacts the seat to cause deterioration of freshness of the passenger and inconvenience.

In order to solve the problem, a ventilation seat is mounted on the vehicle, which discharges cool air onto the surface of the seat from an air conditioner (not illustrated) via a duct to give pleasant ride comfort to the passenger.

Herein, a channel type ventilation seat in the related will be described below.

FIGS. 1A to 1E illustrate a channel type ventilation seat in the related art.

The channel type ventilation seat 200 in the related art is configured to include a seat pad 210 and a sponge type slab 220 stacked on the seat pad 210.

A duct connection hole 212 is formed on the bottom of the seat pad 210 and a channel 214 which is in communication with the duct connection hole 212 is branched on the top of the seat pad 210.

A plurality of air discharge holes 222 which match the channels 214 penetrate the slab 220.

Accordingly, the slab 220 is stacked on the top of the seat pad 210 and herein, the slab 220 is stacked so that the channel 214 of the seat pad 210 and the air discharge hole 222 of the slab 220 match each other and a duct connected with an air blower is joined to the duct connection hole 212 of the seat pad 210.

In this case, the air discharge hole 222 at a terminal side of the slab 220 needs to accurately match the end of the channel 214 of the seat pad 210 and the reason is to make an air flow be smooth and prevent the air flow from being lost.

As a result, the air from the air blower is branched into the channels 214 of the seat pad 210 to flow via the duct and thereafter, discharged through the air discharge hole 222 formed in the slab 220 thereon, and as a result, a seat sitter feels coolness.

However, as illustrated in FIG. 1D, during a process of stacking and assembling the slab 220 onto the seat pad 210, a fault may occur, in which the channel 214 of the seat pad 210 and the air discharge hole 222 of the slab 220 do not accurately match each other and are assembled in an eccentric state, and as a result, there is a problem that the air flow is interrupted and the air flow is lost.

As illustrated in FIG. 1E, there is a problem that a phenomenon occurs, in which the slab 220 and the seat pad 210 are pressed by a load of the sitter, and as a result, the channel 214 of the seat pad 210 and the air discharge hole 222 of the slab 220 are blocked.

Herein, a mat type ventilation seat in the related will be described below.

FIGS. 2A to 2E illustrate a mat type ventilation seat in the related art.

The mat type ventilation seat 300 in the related art is configured to include a seat pad 310, and felt 320 and a mat 330 sequentially stacked on the bottom of the seat pad 310.

A plurality of air discharge holes 312 vertically penetrate in the seat pad 310.

Air via holes 322 that match the air discharge holes 312 of the seat pad 310 penetrate in the felt 320.

A duct connection hole 334 is formed at the center of the mat 330 and a plurality of air guide protrusions 332 that closely contact the bottom of the felt 320 protrude on the top of the mat 330.

Accordingly, the felt 320 is stacked on the bottom of the seat pad 310 and herein, the felt 320 needs to be stacked so that the air discharge hole 312 of the seat pad 310 and the air via hole 322 of the felt 320 accurately match each other and further, when the mat 330 is stacked on the bottom of the felt 320, since the air guide protrusion 332 closely contacts the bottom of the felt 320, the felt 320 and the mat 330 are spaced apart from each other for the air flow as large as the thickness of the air guide protrusion 332.

As a result, the air from the air blower is discharged through the air via holes 322 of the felt 320 and the air discharge holes 312 of the seat pad 310 by passing between the air guide protrusions 332 via the duct, and as a result, the seat sitter feels the coolness.

However, as illustrated in FIG. 2D, during a process of stacking the felt 320 on the bottom of the seat pad 310, a fault occurs, in which the air discharge holes 312 of the seat pad 310 and the air via holes 322 of the felt 320 do not accurately match each other and are assembled in the eccentric state, and as a result, there is a problem that the air flow is interrupted and the air flow is lost.

As illustrated in FIG. 2E, there is a problem that a phenomenon occurs, in which the seat pad 310 is pressed by the load of the sitter, and as a result, the air discharge holes 312 formed on the seat pad 310 and the air discharge holes 312 deteriorate to be clogged.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to solve the above-described problems associated with prior art and to provide a ventilation seat for a vehicle. In one aspect, a ventilation seat for a vehicle includes a seat pad having opposing lower and upper portions. The lower portion has an air branching channel formed therein. The seat pad has a plurality of air discharge holes arranged in a configuration that matches the air branching channel. The air discharge holes penetrated from the upper portion to the lower portion of the seat pad. A channel finish plate is attached to the lower portion of the seat pad and seals the air branching channel. The channel finish plate includes a duct connection hole penetrating therethrough. In certain embodiments, the channel finish plate may include an air guide configured to guide air toward the air branching channel. The air guide may be disposed over the duct connection hole of the channel finish plate. In certain embodiments, the air guide may be integrally formed with the channel finish plate.

In certain embodiments, the air guide may include two or more air guide holes penetrating a circumferential surface of the air guide, the guide holes and a flow guide formed on the top of the air guide. The air guide holes may be in communication with the air branching channel of the seat pad. In certain embodiments, the flow guide may have a shape which is convex in a direction towards the duct connection hole. In certain embodiments, a matching guide which is convex toward the channel finish plate may be integrally formed on the seat pad at the center of the air branching channel to match the flow guide.

In certain embodiments, at least one guide protrusion may be integrally formed on the channel finish plate at a location which matches at least one of the air discharge holes of the seat pad. The guide protrusion may be configured to guide air toward the air discharge hole.

In certain embodiments, a hard foam material may be integrally foam-molded at a part on the seat pad where the air branching channel is formed. In certain embodiments, the lower portion of the seat pad including the air branching channel may be foam-molded out of hard foam material.

Through the aforementioned problem solving means, embodiments of the present invention provide the following advantages.

First, unlike a phenomenon in which an air flow is interrupted during the existing assembly process, since an air flow path up to an air discharge hole of a seat pad from a duct to make the air flow can be smooth, the performance of a ventilation seat can be improved.

Second, as in certain embodiments, an air branching channel of the seat pad may be molded of a hard foam material, the air branching channel is not deformed even due to a load of a passenger to easily prevent a phenomenon in which the air discharge hole of the seat pad is clogged.

Other aspects and embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (for example, fuels derived from resources other than petroleum). As referred to herein, a hybrid vehicle is a vehicle that has two or more sources of power, for example both gasoline-powered and electric-powered vehicles.

The above and other features of embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIGS. 1A to 1E illustrate a channel type ventilation seat in the related art;

FIGS. 2A to 2E illustrate a mat type ventilation seat in the related art;

FIGS. 3 and 4 are perspective views illustrating a seat pad of the ventilation seat for a vehicle according to an embodiment of the present invention;

FIG. 5 is a cross-sectional view illustrating the seat pad of the ventilation seat for a vehicle according to an embodiment of the present invention;

FIG. 6 is a perspective view illustrating a channel finish plate of the ventilation seat for a vehicle according to an embodiment of the present invention;

FIG. 7 is a separation perspective view illustrating the ventilation seat for a vehicle according to an embodiment of the present invention;

FIG. 8 is a longitudinal cross-sectional view illustrating the ventilation seat for a vehicle according to an embodiment of the present invention;

FIG. 9 is a transverse cross-sectional view illustrating the ventilation seat for a vehicle according to an embodiment of the present invention;

FIG. 10 is a perspective view illustrating one method of molding an air branching channel of the ventilation seat for a vehicle by a hard foam material according to an embodiment of the present invention;

FIG. 11 is a cross-sectional view taken along line A-A of FIG. 10; and

FIG. 12 is a cross-sectional view illustrating another method of molding the air branching channel of the ventilation seat for a vehicle by the hard foam material according to an embodiment of the present invention.

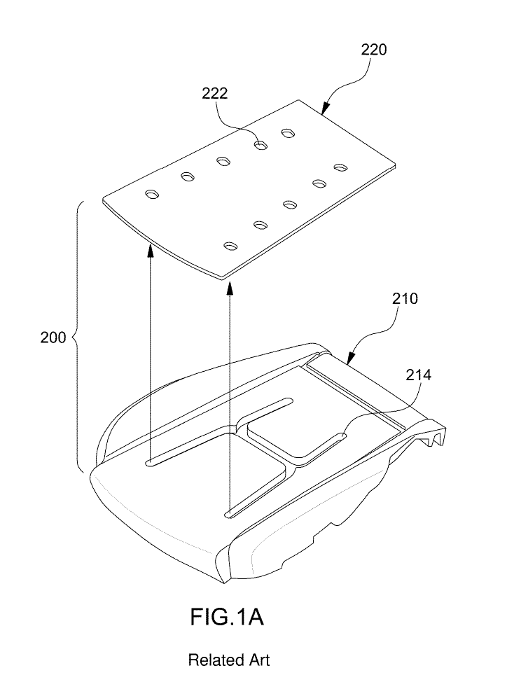

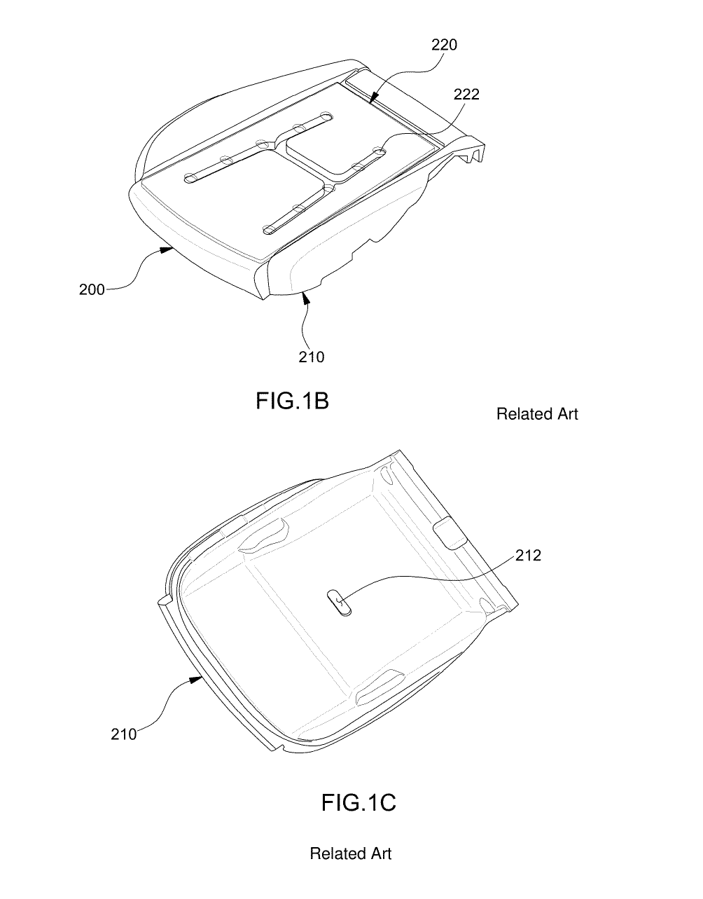

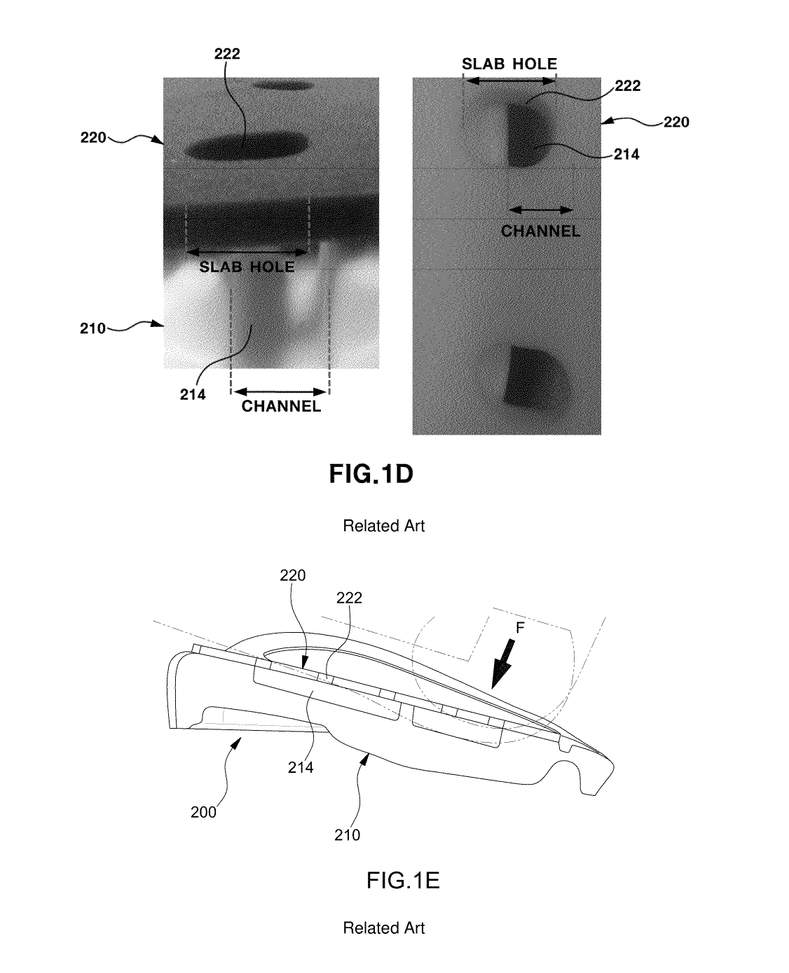

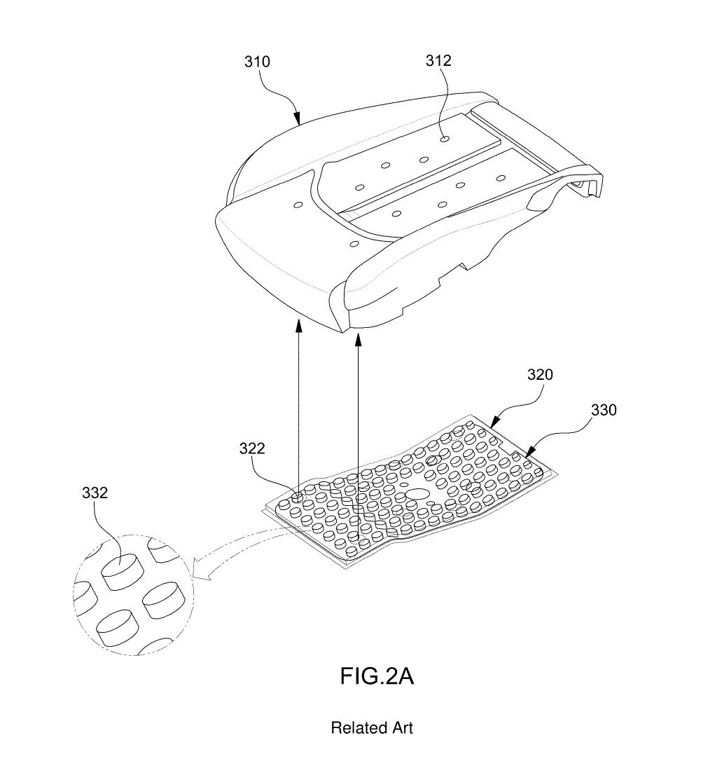

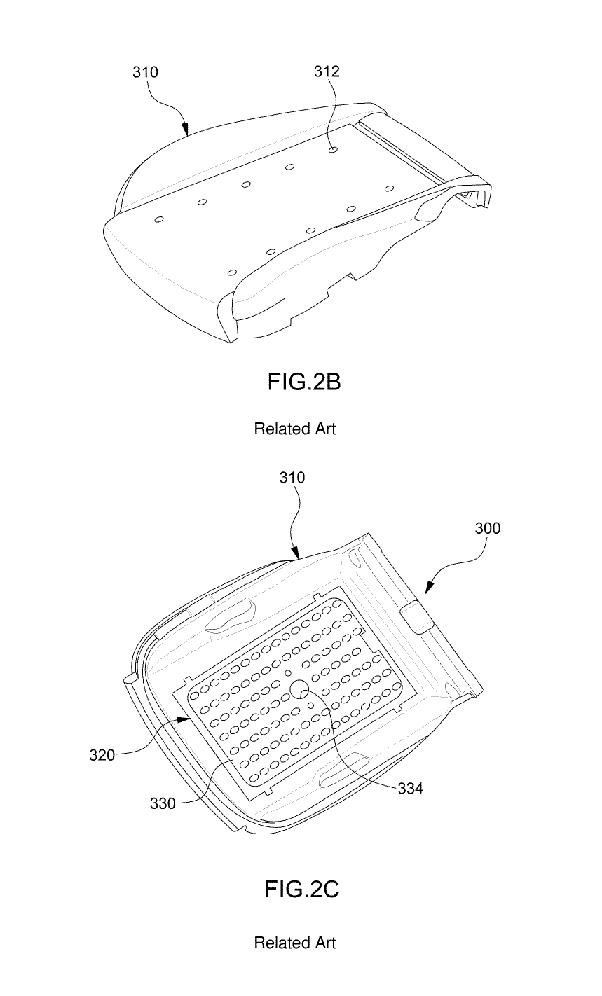

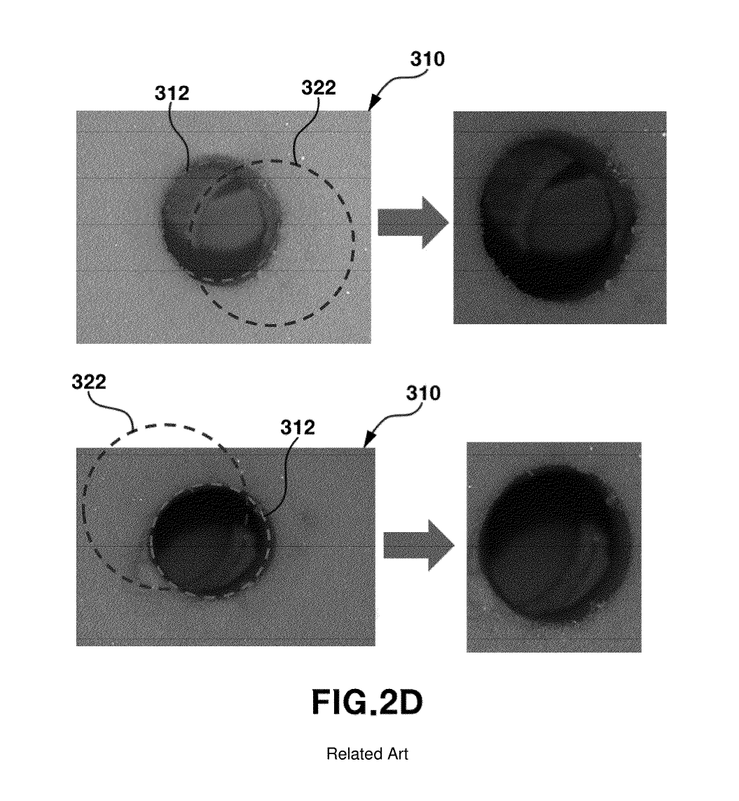

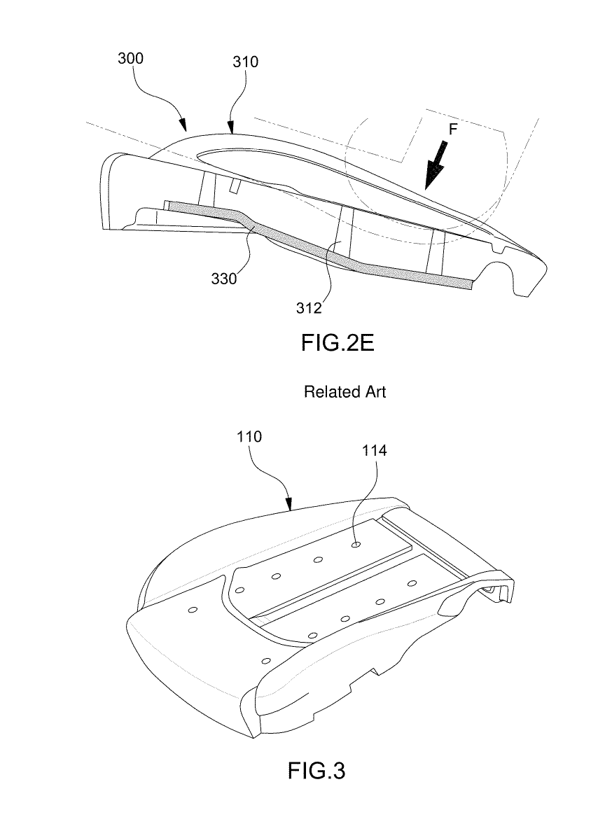

It should be understood that the appended drawings are not necessarily to scale, presenting a somewhat simplified representation of various features illustrative of the basic principles of the invention. The specific design features of embodiments of the present invention as disclosed herein, including, for example, specific dimensions, orientations, locations, and shapes will be determined in part by the particular intended application and use environment.

In the figures, reference numbers refer to the same or equivalent parts throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, embodiments of the present invention will be described in detail with reference to the accompanying drawings.

Certain embodiments of the present invention provide a ventilation seat for a vehicle, which can make an air flow up to a final discharge hole of a seat from an air duct be smooth and easily prevent a phenomenon in which an air discharge hole is clogged.

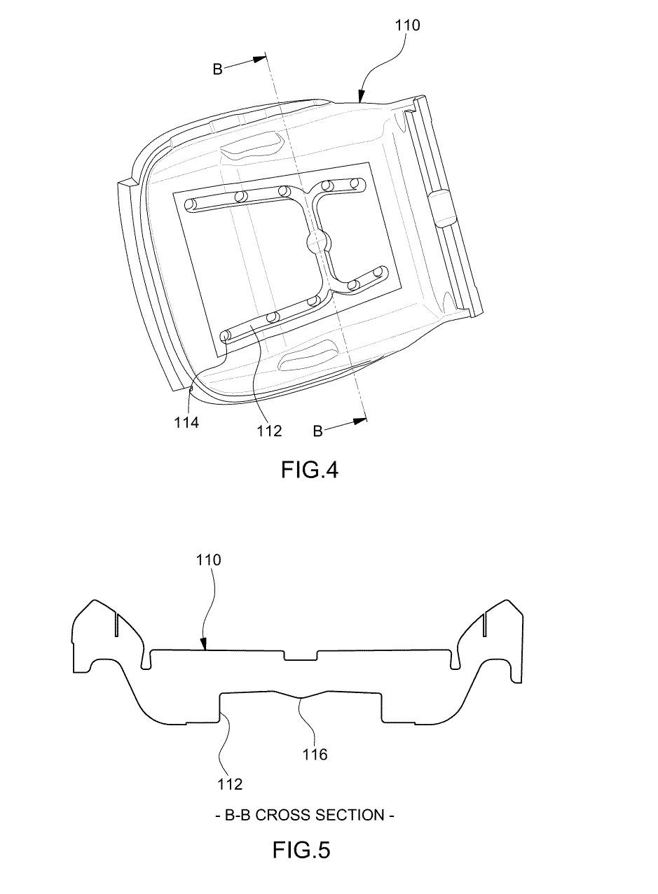

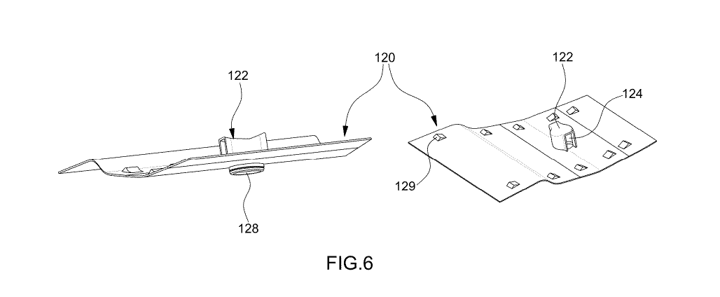

FIGS. 3 and 4 are perspective views illustrating a seat pad of the ventilation seat for a vehicle according to an embodiment of the present invention. FIG. 6 is a perspective view illustrating a channel finish plate of the ventilation seat for a vehicle according to an embodiment of the present invention.

The ventilation seat 100 according to an embodiment of the present invention is configured to include a seat pad 110 and a channel finish plate 120.

The seat pad 110 has a structure in which an air branching channel 112 is formed on the bottom and a plurality of air discharge holes 114 that match the air branching channel 112 penetrate on the top.

As illustrated in FIGS. 3 and 4, the air branching channel 112 of the seat pad 110 has a groove structure having an “H” shape around a position connected with an air duct and air discharge holes 114 that penetrate toward the top of the seat pad 110 are formed at a regular interval along the air branching channel 112.

In this case, a matching guide 116 that is convex downward integrally protrudes at the center of the air branching channel 112 of the seat pad 110, that is, a location where air is initially branched as illustrated in FIG. 5 and the matching guide 116 becomes a part that closely contacts a flow guide 126 of an air guide 122 formed on the channel finish plate 120 as described below.

The channel finish plate 120 is provided in a hard plate body structure which is curved according to a bottom curve shape of the seat pad 110 and a duct connection hole 128 penetrates at a location which matches the matching guide 116 of the seat pad 110 as illustrated in FIG. 6.

In certain embodiments, the air guide 122 that guides air from the bottom to the top to the air branching channel 112 positioned in a horizontal direction is integrally formed at a top location which matches the duct connection hole 128 of the channel finish plate 120.

In certain embodiments, the air guide 122 has a cylindrical shape and two or more air guide holes 124 that are in communication with the air branching channel 112 of the seat pad 110 penetrate on a circumference surface of the air guide 122 and the flow guide 126 that is convex downward integrally protrudes on the top of the air guide 122.

A guide protrusion 129 that guides air upward, that is, toward the air discharge hole 114 integrally protrudes at locations on the top of the channel finish plate 120, which match the air branching channel 112 and the air discharge hole 114 of the seat pad 110.

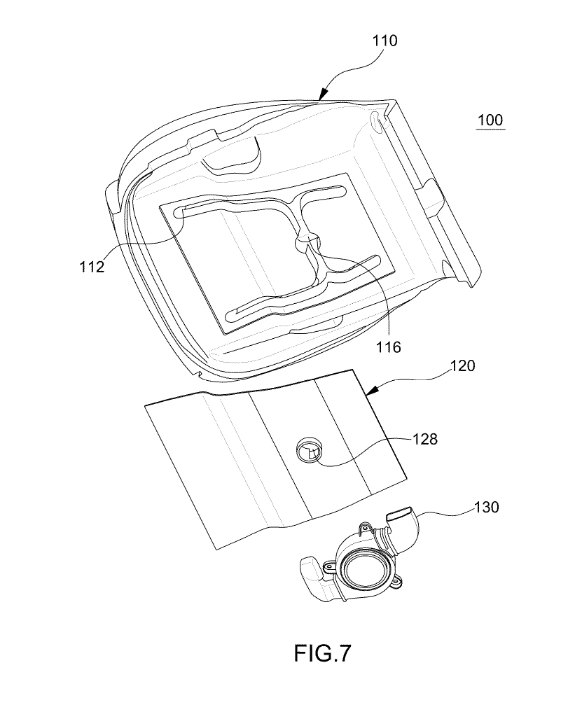

The channel finish plate 120 provided as above is attached to the bottom of the seat pad 110 to airtightly seal the air branching channel 112 as illustrated in FIG. 7.

In this case, when the channel finish plate 120 is attached to the bottom of the seat pad 110, the flow guide 126 formed on the top of the air guide 122 closely contacts the matching guide 116 of the seat pad 110 to match each other, and as a result, an attachment location of the channel finish plate 120 on the bottom of the seat pad 110 may be accurate continuously.

As the channel finish plate 120 is accurately attached to an assembly location of the seat pad 110, an air flow path up to the air branching channel 112 and the air discharge hole 114 of the seat pad 110 from the air guide 122 of the channel finish plate 120 may be accurately formed without any assembly deviation.

Herein, an operation flow of the ventilation seat of an embodiment of the present invention will be described below.

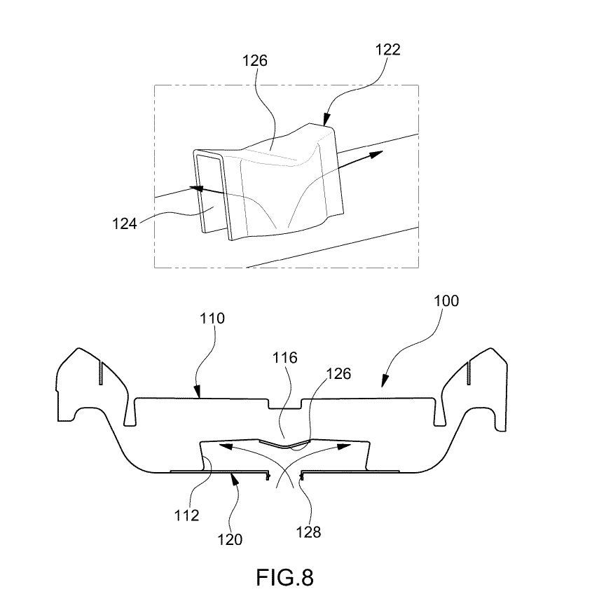

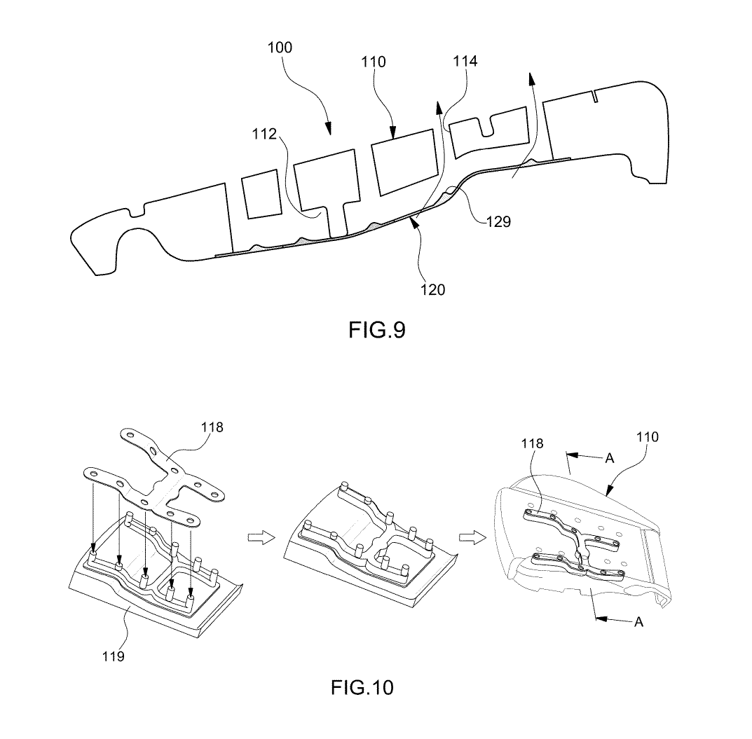

FIGS. 8 and 9 are a longitudinal cross-sectional view and a transverse cross-sectional view illustrating the ventilation seat for a vehicle according to an embodiment of the present invention.

First, the air from the air blower detours the duct 130 and thereafter, is supplied upward toward the duct connection hole 128 of the channel finish plate 120.

Subsequently, at the moment when the air passes through the duct connection hole 128 and contacts the flow guide 126 of the air guide 122 while being supplied into the air guide 122 thereabove, a flow direction of the air is switched to a horizontal direction to get out of the air guide hole 124 of the air guide 122.

Simultaneously, the air discharged from the air guide hole 124 of the air guide 122 flows along the air branching channel 112 of the seat pad 110.

Subsequently, at the moment when air that flows along the air branching channel 112 hits the guide protrusion 129 of the channel finish plate 120, the air is discharged through the air discharge hole 114 of the seat pad 110 while the flow direction of the air is switched toward the top, and as a result, the seat sitter feels the coolness.

As described above, since the air flow up to the air discharge hole 114 of the seat pad 110 from the duct 130 may be smooth without any interference, the performance of the ventilation seat may be improved.

Meanwhile, in order to prevent a phenomenon in which the seat pad 110 is pressed by the load of the sitter, and as a result, the air discharge hole 114 is clogged while the air branching channel 112 formed on the seat pad 110 is deformed, the hard foam material 118 is integrally foam-molded at a part on the seat pad 110 where the air branching channel 112 is formed.

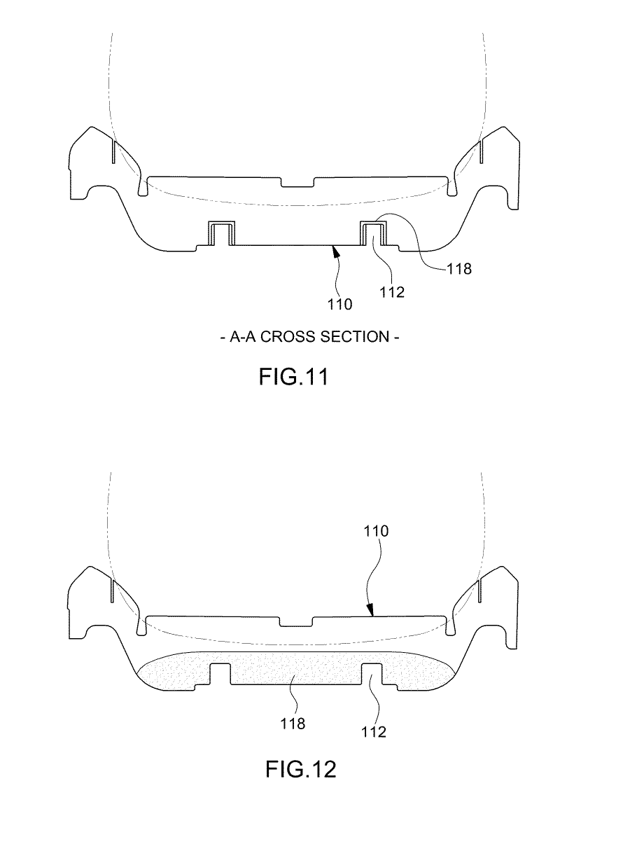

To this end, as illustrated in FIGS. 10 and 11, the hard foam material 118 is disposed at a formation part of the air branching channel 112 in a female mold 119 for foam-molding the seat pad and the seat pad 110 is foam-molded together with the hard foam material 118, and as a result, the hard foam material 118 is integrally foam-molded at the part on the seat pad 110 where the air branching channel 112 is formed.

Accordingly, the hard foam material 118 endures the load of the sitter to easily prevent the phenomenon in which the air discharge hole 114 is clogged while the air branching channel 112 formed on the seat pad 110 is deformed.

Alternatively, as illustrated in FIG. 12, when the hard foam material 118 is integrally form-molded on the seat pad 110, even though not the air branching channel 112 part but a lower part of the seat pad 110 in a vertical direction is foam-molded by the hard foam material 118, it is possible to easily prevent the phenomenon in which the air discharge hole 114 is prevented while the air branching channel 112 formed on the seat pad 110 is deformed.

The invention has been described in detail with reference to embodiments thereof. However, it will be appreciated by those skilled in the art that changes may be made in these embodiments without departing from the principles and spirit of the invention, the scope of which is defined in the appended claims and their equivalents.

What is claimed is:

1. A ventilation seat for a vehicle, the ventilation seat comprising:
a seat pad having opposing lower and upper portions, the lower portion having an air branching channel formed therein, the seat pad having a plurality of air discharge holes arranged in a configuration that matches the air branching channel, the air discharge holes penetrating from the upper portion to the lower portion; and
a channel finish plate attached to the lower portion of the seat pad and sealing the air branching channel, the channel finish plate including a duct connection hole penetrating therethrough.

2. The ventilation seat of claim 1, wherein the channel finish plate comprises an air guide configured to guide air toward the air branching channel and is disposed over the duct connection hole of the channel finish plate.

3. The ventilation seat of claim 2, wherein the air guide includes two or more air guide holes penetrating a circumferential surface of the air guide, the air guide holes in communication with the air branching channel of the seat pad, and a flow guide formed on the top of the air guide.

4. The ventilation seat of claim 3, wherein a matching guide which is convex toward the channel finish plate is integrally formed on the seat pad at the center of the air branching channel to match the flow guide.

5. The ventilation seat of claim 1, wherein at least one guide protrusion is integrally formed on the channel finish plate at a location which matches at least one of the air discharge holes of the seat pad, the at least one guide protrusion configured to guide air toward the at least one of the air discharge holes.

6. The ventilation seat of claim 1, wherein a hard foam material is integrally foam-molded at a part on the seat pad where the air branching channel is formed.

7. The ventilation seat for 1, wherein the lower portion of the seat pad including the air branching channel is foam-molded out of hard foam material.

8. The ventilation seat of claim 2, wherein the air guide is integrally formed with the channel finish plate.

9. The ventilation seat of claim 3, wherein the flow guide has a shape which is convex in a direction towards the duct connection hole.
